(19) United States
(12) Patent Application Publication
(10) Pub. No.: US 2011/0221758 A1
(43) Pub. Date: Sep. 15, 2011

(54) Apparatus and Method for Manipulating Images through a Computer

(76) Inventor: Robert Livingston, Newport Beach, CA (US)

(21) Appl. No.: 13/042,735

(22) Filed: Mar. 8, 2011

Related U.S. Application Data
(60) Provisional application No. 61/312,966, filed on Mar. 11, 2010.

(51) Int. Cl. G06F 3/033; G09G 5/00; G06F 3/041

(52) U.S. Cl. 345/581; 345/173; 345/161

(57) ABSTRACT

An apparatus and method for a subject to provide input to a computer in order to generate and manipulate displayed images. The subject physically interacts with at least one input modality within an input console that is coupled to the computer. The input console converts the provided physical input into a corresponding electronic signal which is received by a graphic graphics module stored within the computer. The graphics module associates the incoming electronic signal with an image to be displayed or to an action or visual effect to be applied to a pre-existing image. The visual effect changes the image and creates a unique second image based on the input provided by the subject. A user may manipulate the image further and then save, print, or transfer the second image to another computer or device for a variety of applications.

### RELATED APPLICATIONS

The present application is related to U.S. Provisional Patent Application Ser. No. 61/312,966, filed on Mar. 11, 2010, which is incorporated herein by reference and to which priority is claimed pursuant to 35 USC 119.

### BACKGROUND OF THE INVENTION

1. Field of the Invention

The invention relates to the field of computer hardware and software allowing for the manipulation of on screen images, specifically for infants or pets to input commands into a computer and an image being modified or distorted corresponding to those input commands.

2. Description of the Prior Art

Computers and computer software systems have long been used to create and/or modify graphical images for an unknown multitude of applications. These systems can range from the very basic for the average lay person such as Microsoft® Paint®, to the very complex such as computer assisted design programs for engineers or scientists. However the basic element in common in which all these various graphic and illustration programs possess is that they are meant to be used by young children or adults possessing a certain degree of computer proficiency through traditional manipulation of an image by means of a keyboard and a mouse coupled to the computer. Those wishing to have their infants or pets use a computer in order to manipulate an image for the purposes of creating mementos and the like have been unable to do so because of the inherent inability for infants or pets to possess and maintain basic computer skills.

What is needed therefore is a method and apparatus allowing those without any experience or knowledge of computers to input commands into a computer for the purposes of creating a unique graphical image which then may be printed or otherwise displayed.

### BRIEF SUMMARY OF THE INVENTION

A system for generating and manipulating an image through input received from a subject including a computer, a video output device coupled to the computer for displaying an image generated with the computer, and a input console having a plurality of input modalities coupled to the computer and disposed in proximity to the subject for generating at least one input signal by interaction with the subject. The computer also includes a graphics module for converting the at least one input signal generated by the input console into a visual effect applied to the image displayed by the video output device.

The input console includes a plurality of transducers coupled to the corresponding plurality of input modalities and coupled to the graphics module within the computer. The plurality of input modalities of the input console may include a pressure pad with a plurality of active areas, a plurality of illuminated buttons, a joystick, and a recessed dish coupled to a transducer to sense contact therewith by the subject.

In another embodiment, the input console is directed to specific use with household pets. The plurality of input modalities of the input console of this embodiment include a chew toy with a coupled transducer to sense interaction of the subject with the chew toy, a pull toy with a coupled transducer to sense interaction of the subject with the pull toy, and a speaker and a microphone.

The current invention also provides for a method for generating and manipulating an image through input received from a subject including attracting the subject to an input console coupled to a computer and the subject physically interacting with at least one input modality of the input console. The physical interactions of the subject are then converted into input signals and then sent to a graphics module configured within the computer which then associates the received electronic signal with a visual effect to be applied to a first image generated by the computer. The associated visual effect is then applied to the image displayed on a video output device coupled to the computer to create a second image.

In one embodiment, the method step of converting the physical interactions of the subject into the input signals includes converting the physical interactions of the subject into the input signals via at least one transducer coupled to the at least one input modality of the input console.

In another embodiment, the method step of the subject physically interacting with at least one input modality of the input console includes touching a pressure pad, selecting one of a plurality of buttons, moving a joystick, removing weight from a recessed dish, chewing on a chew toy, pulling on a pull toy, or making audible noises through a microphone.

In yet another embodiment, the method step of converting the physical interactions of the subject into electronic signals further includes converting each physical interaction of the subject into an input modality specific input signal. This allows for the received input signal to be associated with a specific visual effect to be applied to a first image.

In another embodiment, the method step of applying the associated visual effect to the first image displayed by the video output device coupled to the computer to create a second image includes applying a plurality of visual effects to the first image.

In still yet another embodiment, the method further includes associating the received electronic signal with a new image to be displayed by the video output device coupled to the computer, or saving the second image to a memory storage device or other computer readable medium. The method may further include stopping the application of the plurality of visual effects to the first image by means of user selection and sequentially reviewing each visual effect after it had been applied to the first image. The application of the plurality of visual effects to the first image after review may then be resumed by means of user selection.

Finally, the invention also provides for a graphics module and an internal memory device within a computer for completing the method of generating and manipulating an image through input received from a subject.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1 is isometric view of the current invention including a computer, a screen, and an input module.

FIG. 2 is a magnified perspective view of the input console comprising a plurality of input modalities.

FIG. 3 is a magnified perspective view of an alternative embodiment of the input console comprising an alternate selection of a plurality of input modalities.

FIG. 4 is perspective split view of a subject interacting with the input console and the manipulation of the image displayed in response to the subject's interaction.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

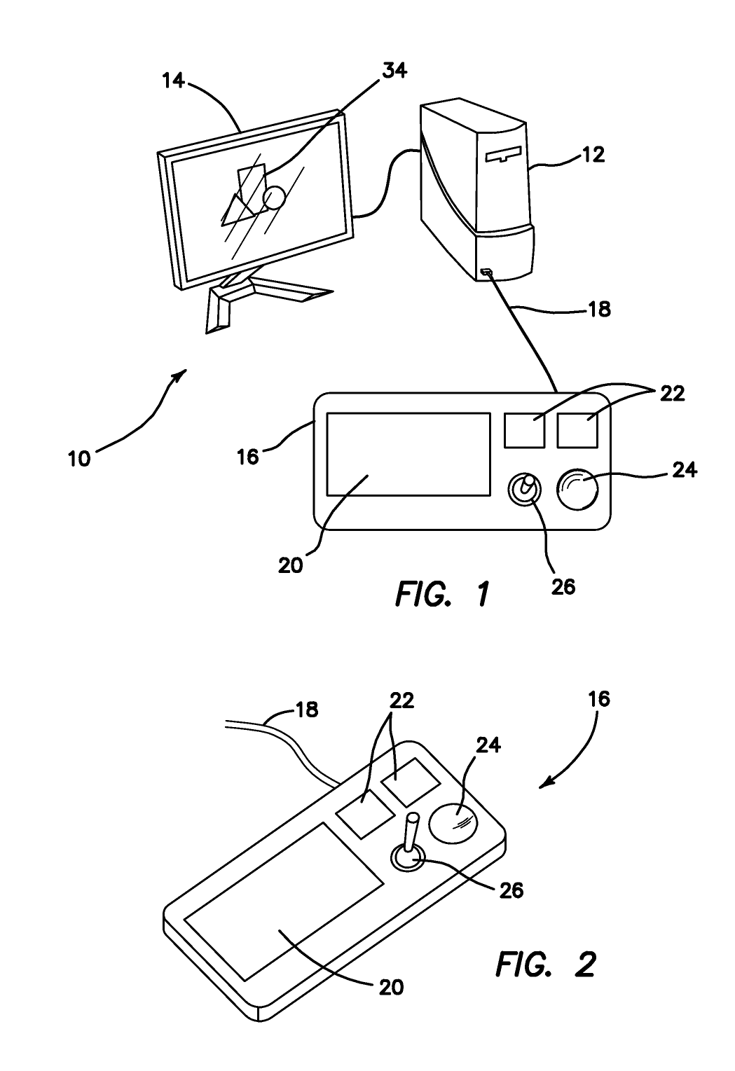

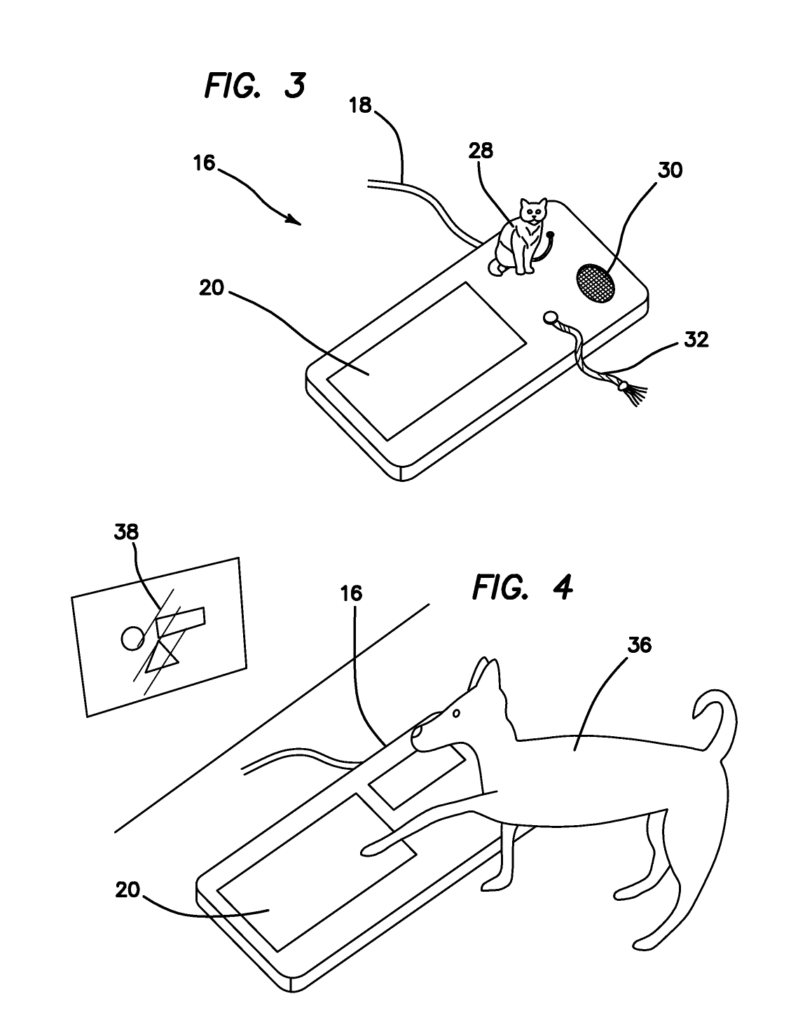

A general representation of the current system may be seen in FIG. 1 and is generally denoted by reference numeral 10. The system 10 comprises a computer 12 coupled to a monitor or screen 14 by means well known in the art. Also coupled to the computer 12 is an input console 16 which serves as the means for an infant, pet, or other subject to provide input in order to change or manipulate an image displayed on the screen 14. The console 16 is coupled to the computer by means well known in the art, preferably through a standard a universal serial bus (USB) port and a standard USB cable 18 coupled to the console 16. The console 16 may also be coupled to the computer 12 wirelessly through a Blue Tooth® connection or equivalent means so as to give the console 16 sufficient range from the computer 12. Also included in the system 10 is an imaging manipulation software program stored within the internal memory hardware of the computer or on a removable computer readable media such as a compact disc or memory stick.

The input console 16 is substantially flat and is preferably placed on the ground proximate to the computer 12. The input console 16 principally serves as means for the subject to provide input into the system 10 without the subject having any pre-existing knowledge of computers or basic computer skills. In one embodiment seen in FIGS. 1 and 2, the console 16 comprises a plurality input means including but not limited to a pressure pad 20, a plurality of buttons 22, a recessed dish 24, and a joystick 26. The pressure pad 20 is substantially rectangular and is disposed over the majority of the console 16. The pressure pad 20 is coupled to a plurality of transducers and circuits within the console 16 as is well known in the art that correspond to the different portions of the pad 20. When a subject such as a pet or infant presses down on the pad 20, the amount of downward force and location of where the force is applied to the area of the pad 20 is converted into an electrical signal by the transducers and is then sent on to the computer 12 via the USB cable 18 or wireless connection. Similarly, the plurality of buttons 22 are also coupled to internal transducers so that when pressed, a corresponding signal is sent to the computer 12. The buttons 22 may light up in a plurality of colors, flash or pulsate, or otherwise react when pressed so as to attract or entice the subject into further physical contact with the console 16. The joystick 26 also provides a similar means of input, a corresponding signal being created for each direction in which the joystick 26 is moved by the subject. The recessed dish 24 within the console 16 provides an area in which food, treats, or other objects may be placed to attract the subject to the system 10. As the subject removes food from the dish 24, pressure sensitive transducers coupled to the dish 24 convert the weight differential into a corresponding electrical signal which is then sent to the computer 12 and processed by the software therein to manipulate an image as will be further detailed below.

In an alternative embodiment, the console 16 comprises input means specifically directed to pets, specifically cats, dogs, and the like. In addition to the pressure pad 20 the console 16 also comprises a coupled chew toy 28, a two-way speaker 30 comprising a microphone, and a coupled pull toy 32. The chew toy 28 is permanently coupled to the console 16 in a fixed position and is comprised of soft rubber or a soft plush material in the form of a small animal or other shape that attracts the pet. As the pet strikes or chews on the chew toy 28, an electrical signal is generated by a plurality of transducers within the console 16 and chew toy 28 and is transmitted to the computer 12. Similarly, the pull toy 32 is coupled to the console 16 such that when the pet pulls or tugs on the pull toy 32, an electrical signal is generated that corresponds to the specific direction and amount of force in which the pull toy 32 is directed. The two-way speaker 30 emits sounds or noises that may attract the pet to the system 10. For example, in the case of dog, the sound of the voice of the dog's master or that of another animal may stimulate the dog into physically interacting with the console 16. The speaker 30 also comprises a microphone and serves as an input means for the subject, converting any audible noise emitted by the subject such as barking, growling, and the like into an electrical signal by means well known in the art. It is to be expressly understood that other well known pet toys such as catnip toys, scratching posts, bat or bobble toys, or any other pet toy now known or later devised may be similarly coupled to the input console 16 via a plurality of internal transducers without departing from the original spirit and scope of the invention.

Software code in which the current invention is comprised of is stored on the computer 12 via an internal memory coupled to a processing unit as is well known in the art. The software program of the current invention may be transferred to the internal memory of computer 12 by a computer readable medium such as a compact disc or flash drive, or alternatively downloaded from a website or other outside source via an internet connection. Once the input console 16 has been properly coupled to the computer 12, the software begins to coordinate commands received from the input console 16 in order to change or manipulate an image 34 displayed on the screen 14 as seen in FIG. 1 and as detailed below.

After the system 10 has been properly initialized and the input console 16 has been placed on the ground and coupled to the computer by the USB cable 18 or a wireless connection, the subject is enticed to interact with the input console 16. This may be done in by calling the child or pet over, attracting the subject with lights emitted from the plurality of buttons 22, sound emitted from the speaker 30, food or treats placed in the dish 24, enticement from the chew toy 28 or pull toy 32, or any combination thereof. Additionally, the subject may interact with the input console 16 at random, such as stepping, rolling, or laying on the pressure pad 20 and buttons 20, or by accidently hitting or brushing up against the joystick 26. Regardless of how it's accomplished, the subject provides their input to the software through the input console 16 and its plurality of input modalities. In FIG. 4, a subject 36 is seen making contact with the pressure pad 20 by stepping on it, however this is meant to be for illustrative purposes only. The subject 36 may provide input through any of the means or combination of means disclosed above and is not limited to what is explicitly depicted in the figures.

Once the input from the subject 36 has been received, a signal corresponding to the specific type of input modality is created by one or more transducers or by other equivalent means well known in the art for converting mechanical force into an electrical signal. The signal is then sent to the software stored in the computer 12 via the USB cable 18 or wireless connection. In addition to the signal being modality specific, the signal may also correspond to a specific value associated for that modality. For example if input is received through the pressure pad 20, the amount of pressure and specific location of where the pressure is applied within the pressure pad 20 itself may be represented within the generated signal. It is therefore contemplated that if a light pressure is applied to the pressure pad 20, a first visual effect will be applied to the image, while if a large amount of pressure is applied to the pressure pad 20, a second visual effect that is different from the first will be applied to the image. The same process may be applied to the directionality of the input modality. For example if the pull toy 32 is pulled substantially to the left, a first visual effect will be applied to the image, while if the pull toy 32 is pulled substantially to the right, a second visual effect that is different from the first will be applied to the image. It is in this fashion therefore that the current invention provides a means for a subject to create a unique image through unconventional input.

After the signal has been generated and then received by the computer 12, the software then associates the incoming signal to an image or an action or visual effect to be applied to a pre-existing image. The software then displays a first image 34 on the screen 14 as seen in FIG. 1, or alternatively modifies the first image 34 into a second image 38 as seen in FIG. 4. The image that is displayed or how an image is modified is completely dependent upon the signal generated by the subject. For example if one of the plurality of buttons 22 is pressed by the subject, the color of the image displayed on the screen 14 may change, while if the pull toy 32 is pulled with sufficient force, the image displayed on the screen 14 may rotate, deform, or otherwise be modified. Similarly, other input means of the input module 16 such as those discussed above may also produce each of their own corresponding action or visual effect applied to the image when selected. These actions or visual effects may include but are not limited to shading, shape changing, size modification, pattern making, color addition/subtraction, or any other image modifying or creating tool now known or later devised. In FIGS. 1 and 4 the first image 34 and the second image 38 are shown to be a series of geometric shapes, however this is for illustrative purposes only. It is to be expressly understood that any combination of shapes, colors, text, photographs, or other visual effects may be used in the image generating process.

As a plurality of input signals are received, the software will continue to generate and display an aggregate image of all of the input signals received from the subject. A user or computer operator using a keyboard or mouse coupled to the computer 12 as is known in the art may choose to stop or freeze the image manipulation process at any time and prevent any further input received from the subject from being translated into additional image modification. The user may choose to go back to previous forms or iterations of the image at will or, if they are satisfied with the image created, they may choose to save it to the internal memory of the computer 12 or other data storage device as is known in the art. Alternatively, the user may select for image manipulation to continue, allowing the subject to provide additional input through the input console 16.

The saved image may be later reviewed and then erased, printed by a printer coupled to the computer 12, uploaded to a website, or sent to another computer as an attachment in an email as is well known in the art.

Once the subject generated image has been saved, printed, or sent to another computer, it may be used as a unique, one-of-a-kind design for any number of applications including but not limited to stickers, labels, t-shirts, mugs, pens, pencils, clothes, magnets, dishware, greeting cards, calendars, albums, wall paper, picture frames, automobiles, and the like.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A system for generating and manipulating an image through input received from a subject comprising:
a computer;
a video output device coupled to the computer for displaying an image generated with the computer;
a input console having a plurality of input modalities coupled to the computer and disposed in proximity to the subject for generating at least one input signal by interaction with the subject; and
a graphics module configured within the computer for converting the at least one input signal generated by the input console into a visual effect applied to the image displayed by the video output device.

2. The system of claim 1 wherein the input console comprises a plurality of transducers coupled to the corresponding plurality of input modalities and coupled to the graphics module within the computer.

3. The system of claim 1 where the plurality of input modalities of the input console comprises a pressure pad with a plurality of active areas disposed over a surface of the input console.

4. The system of claim 1 where the plurality of input modalities of the input console comprises a plurality of illuminated buttons disposed on a surface of the input console.

5. The system of claim 1 where the plurality of input modalities of the input console comprises a joystick disposed on a surface of the input console.

6. The system of claim 1 where the plurality of input modalities of the input console comprises a recessed dish defined within the input console and a transducer coupled to the dish to sense contact therewith by the subject.

7. The system of claim 1 where the plurality of input modalities of the input console comprises a chew toy coupled to a surface of the input console and a transducer coupled to the chew toy to sense interaction of the subject with the chew toy.

8. The system of claim 1 where the plurality of input modalities of the input console comprises a pull toy coupled to the surface of the input console and a transducer to sense interaction of the subject with the pull toy.

9. The system of claim 1 where the plurality of input modalities of the input console comprises a speaker and a microphone.

10. A method for generating and manipulating an image through input received from a subject comprising:
attracting the subject to an input console coupled to a computer;
the subject physically interacting with at least one input modality of the input console;
converting the physical interactions of the subject into input signals;
sending the input signals to a graphics module configured within the computer;
associating the received electronic signal with a visual effect to be applied to a first image generated by the computer; and
applying the associated visual effect to the image displayed on a video output device coupled to the computer to create a second image.

11. The method of claim 10 where converting the physical interactions of the subject into the input signals comprises converting the physical interactions of the subject into the input signals via at least one transducer coupled to the at least one input modality of the input console.

12. The method of claim 10 where the subject physically interacting with at least one input modality of the input console comprises:
touching a pressure pad;
selecting one of a plurality of buttons;
moving a joystick;
removing weight from a recessed dish;
chewing on a chew toy;
pulling on a pull toy; or
making audible noises through a microphone.

13. The method of claim 10 where converting the physical interactions of the subject into electronic signals further comprises converting each physical interaction of the subject into an input modality specific input signal.

14. The method of claim 13 where associating the received input signal with a visual effect to be applied to a first image comprises associating the input modality specific input signal with a specific visual effect to be applied to the first image.

15. The method of claim 10 where applying the associated visual effect to the first image displayed by the video output device coupled to the computer to create a second image comprises applying a plurality of visual effects to the first image.

16. The method of claim 10 further comprising associating the received electronic signal with a new image to be displayed by the video output device coupled to the computer.

17. The method of claim 10 further comprising saving the second image to a memory storage device or other computer readable medium.

18. The method of claim 15 further comprising stopping the application of the plurality of visual effects to the first image by means of user selection and sequentially reviewing each visual effect after it had been applied to the first image.

19. The method of claim 18 further comprising resuming the application of the plurality of visual effects to the first image after review by means of user selection.

20. A graphics module and an internal memory device within a computer for completing the method of claim 10.
